(19) United States
(12) Patent Application Publication
(10) Pub. No.: US 2004/0132434 A1
(43) Pub. Date: Jul. 8, 2004

(54) Method and device for processing complaints about mobile telephones

(76) Inventor: Manfred Eschenbacher, Lichtenau (DE)

Correspondence Address: BROWDY AND NEIMARK, P.L.L.C., 624 NINTH STREET, NW, SUITE 300, WASHINGTON, DC, 20001-5303, US

(21) Appl. No.: 10/467,819

(22) PCT Filed: Feb. 7, 2002
(86) PCT No.: PCT/DE02/00460

(30) Foreign Application Priority Data
Feb. 13, 2001 (DE) 101-07-352.6

(51) Int. Cl. H04M 3/42

(52) U.S. Cl. 455/414.1

(57) ABSTRACT

The invention is concerned with a method and a system for processing complaints about mobile telephones and is characterized by the establishment of a software-based service center that can be addressed over the Internet. The service center automates the human consulting process and, in case of a detected defect, offers to place an order for a repair or suggestions for a malfunction correction by the user. The system thus ensures the complete processing of complaints about mobile telephones without the assistance of a human consultant.

The present invention is concerned with a method and device for processing complaints about mobile telephones.

Service for mobile telephones is offered by mobile telephone manufacturers, network operators, service providers and merchants. The objectives of these enterprises are largely congruent.

The processing of complaints, on principle, is divided into two areas for all providers: consultation and/or taking of repair orders, and the actual repair of the defective units.

The following concepts exist for the consultation/taking of repair orders:

Local service network or sales partner network that ensures consultation is provided and repair orders are taken at the given location.

Call center that either takes the repair order itself or refers it to local service partners.

Combined concept, wherein local service or sales partners turn to a call center.

The objective of the consultation/taking of repair orders lies in the

Clarification, whether there actually is a technical problem with the mobile telephone

Prevention of unnecessary repair cases

Examination whether a warranty claim exists

Determination of the type of malfunction

Possible determination of repair costs

Collection of customer and device data

The repair of mobile telephones can take place in different ways:

Repair on location by local service partners, mail-in of difficult cases to central repair centers

Mail-in of all repair cases to central repair centers

Exchange of defective units for an identical unit at the customer's site

Exchange of defective units for an identical unit at the local point of sale

The objective of the repair lies in:

The fastest possible repair of defective units

Low transportation, logistics and repair costs

Short downtimes for the customer.

The shortcoming of all existing service concepts lies in the high personnel costs for the pre-qualification and taking of repairs. Mobile telephones represent a high degree of complexity in the interaction of device hardware, device software, charge card and cellular network. This is the reason for a relatively large number of customer complaints, which result only in part from genuine technical defects. It is the purpose of the consultation and taking of repair orders to distinguish between presumed defects (e.g., operation, incorrect maintenance by the customer) and real defects. If this were not done, considerable costs (transportation, logistics, etc.) would be caused by the non-defective devices without any value in return.

It is the object of the invention to present a method and device that permit a reliable, fast and—with regard to the required personnel—effective processing of complaints about mobile telephones. This object is met with the characteristics of the independent claims.

According to the invention, an IP tool, preferably in the form of an Internet service center (online call center) is established that automates the human consultation process and, in the case of an end user unit defect, permits automatic placement of an order with a repair center. Additionally, however, the system can also offer solutions to the customer (complainant) that do not require an order to be placed with a service center. In the case of operator's mistakes with the devices, the customer is to be provided with suggested solutions that permit him to solve the problem himself. Alternately, the system can name local service partners who perform repairs locally, and automatically place a repair order with them.

To this end, the course of action of the human agents is reproduced in a suitable algorithm. This is done with a so-called CBR program (CBR=Case Based Reasoning). In it, the problem cases and their possible solutions that are created from the wealth of experience of the consultants are deposited and permanently updated. The diagnostics are performed interactively with the customer by means of specific questions by the CBR program that are becoming increasingly more specific over the course of the session.

The advantage of the invention lies in the fact that the customer can bring about a solution for his problem or initiate necessary repair actions conveniently and quickly from his home. The repair and/or exchange of units and accessories can take place very quickly. Additionally, the personnel costs at the service provider's are drastically reduced, since a large part of the consultation and complaint processing can be performed automatically by the inventive system.

The system can offer the client a multitude of solutions after the malfunction has been successfully analyzed. They are, e.g.,:

. . . Immediate help—“call up Menu/Settings . . . and press . . .”

. . . Local Service partners—“contact firm XY, where you can obtain a software update . . .”

. . . Offer of a new unit—“. . . damage caused by liquids is unfortunately irreparable, would you like to purchase a new unit?. . .”

. . . Sale of accessories—“. . . your battery is defective, please click here to order a new battery . . .”

. . . Your unit is defective—“. . . would you like to have it repaired?. . .”

The invention is substantially based on the linking of a knowledge-based database, which quasi represents the “intelligence,” and an existing database that permits placing an order for a repair or exchange process.

The system thus covers the entire service process and permits a fully automatic processing without human assistance.

The system thus is far superior to those systems that, with the use of knowledge-based databases, merely support the human consultation in the Call Center, provide tips for self-help, or refer to a conventional Call Center, which then takes over with further processing. These systems, in comparison to the invention, provide only a small savings potential since no service case can be processed without the conventional personnel costs.

The overall system is thus capable of automatically performing the following functions:

Determining the cause of a malfunction and presenting solutions for a multitude of end user device problems based on the replies entered by the user

Determining the faulty component (battery, receiver, charger) in the case of technical defects

Examination of the warranty claim based on the purchase date entered by the user

Comparison of the end user unit serial number to a black list (examination for previously declined warranty cases)

Comparison of the mobile telephone number to a black list (examination for previously declined warranty cases)

Determining the customer data based on the entered mobile telephone number and card number

Determining the transportation firm that will be used

Determining the anticipated delivery time based on the supply on hand

Issuing model-specific information for an exchange

Fax transmission of the repair order to the user

Data transmission of the repair order to a logistics partner (thus initiating a delivery to the user)

One embodiment of the invention will be described in more detail based on the figures in the drawings. Additional characteristics, advantages and applications of the invention will become apparent from the drawings and their description, in which:

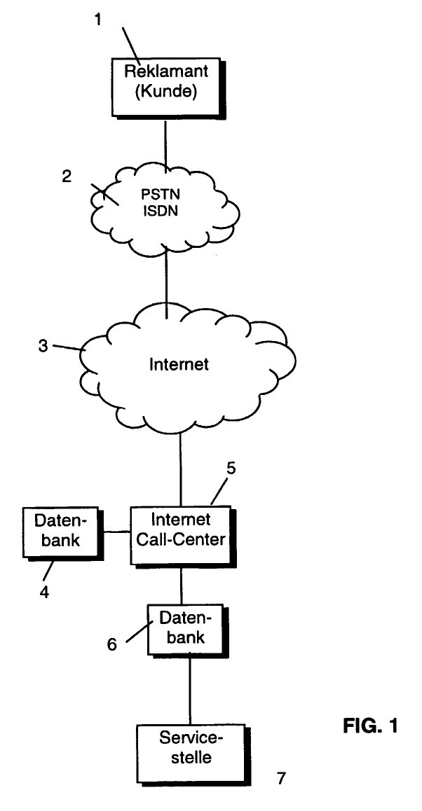

FIG. 1 schematically shows an incorporation of the Internet Service Center into the existing communication networks and participating channels;

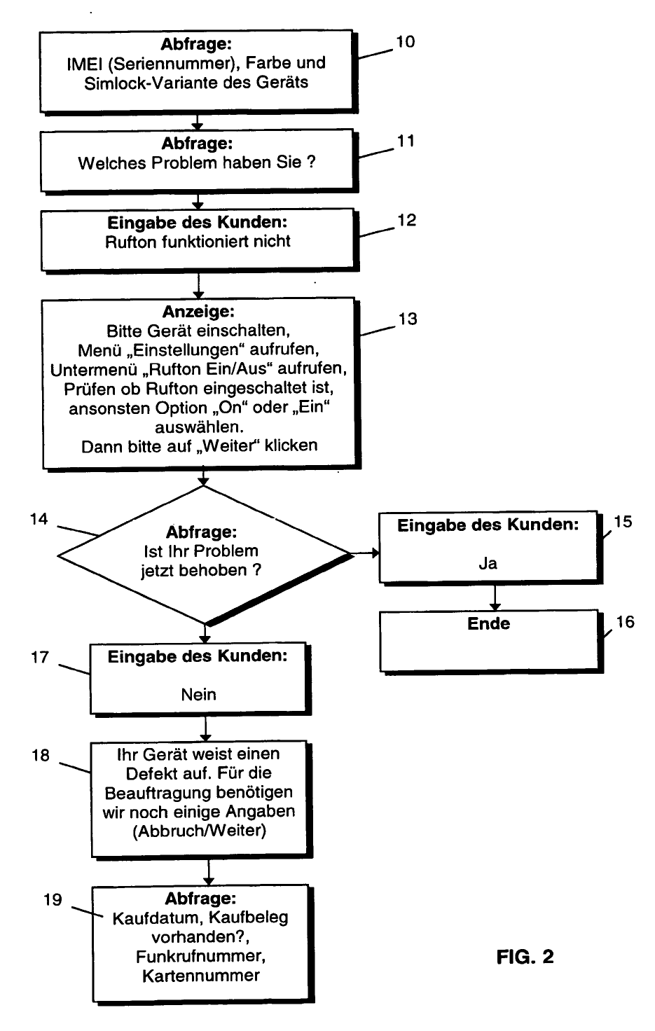

FIG. 2 shows a simple example for the sequence of an automatic consulting session;

As is apparent from FIG. 1, an Internet Service Center 5 is established according to the invention to take complaints, which is executed as an Internet Server that is connected to the Internet 3.

The Internet Service Center 5 can be reached by the complainant (customer) 1 at a certain Internet address. The complainant 1 can establish the Internet connection to the Service Center 5, e.g., by means of a personal computer over the fixed network 2.

The Internet Service Center 5 accesses various databases 4-6, specifically a knowledge-based database 4, in which known problems/questions/malfunctions in connection with mobile telephone end units are stored with their solutions. An additional database 6 contains, e.g., customer information that can be called up by the Service Center. The databases 4-6 are continually updated.

Service and repair centers 7 that are connected to the database 6 can be contacted directly by the Service Center 5 if needed, and charged with a repair.

FIG. 2 shows a simple example for the sequence of a consulting session.

The complainant dials into the system and enters the IMEI (serial number) of his unit. From it, the system determines the type of device and presents a selection of the available colors. The complainant selects the color of his unit. From it, the system determines the available number of simlock variations (special coding of the device). The customer receives support in the form of information on how to distinguish between these variants.

The system then asks which problem the complainant has with his end unit (Step 11). Different options may be provided for entering and narrowing down the problem. The system may, e.g., narrow down the problem with increasingly more specific questions, along the following type: Is your problem related to the hardware or software of the mobile telephone, Is it a malfunction in the display or a tone problem, etc.

The system may, however, also incorporate intelligent text recognition, which permits the problem to be entered directly as a formulated sentence. The complainant enters, e.g., that the ring tone of his mobile telephone is not working (Step 12).

After the system has understood the problem, it searches for a possible solution with the aid of the knowledge-based database. This solution is displayed to the customer: Please switch on your unit, call up “Settings” menu, call up sub-menu “Ring Tone On/Off”, verify whether ring tone is switched on, otherwise select option “On”. Then please click on “Continue” (Step 13).

The complainant is then asked whether the problem has been solved. If this is the case the session is concluded (Steps 15-16).

If the problem has not been solved, the system continues with the problem analysis and suggests additional solutions or concludes that the device has a defect (Steps 18 and 19).

The above example merely reflects the possible sequence of a consulting session In practice the system is capable of analyzing significantly more complex problems in end units and to offer corresponding suggested solutions.

If the problem cannot be independently solved by the system, or if a malfunction occurs that the system does not recognize, the option exists to call in a customer service agent.

What is claimed is:

1. A method for processing complaints about mobile telephones, characterized by the establishment of a service center (5) that automates the human consulting process, is addressed by the complainant (1) via the Internet (3) and, based on a problem/malfunction solution database (4), automatically performs a problem/malfunction analysis in the dialog with the complainant (1) and offers to the complainant an immediate placement of a repair order or, alternately, presents appropriate solutions for a correction of the problem/malfunction by the user.

2. A method according to claim 1, characterized in that the malfunction analysis is performed interactively with the complainant (1) through targeted questions that become increasingly more specific over the course of the session.

3. A method according to any of the above claims, characterized in that the problem/malfunction solutions database (4) is continually updated.

4. A method according to any of the above claims, characterized in that the service center (5), in the case of a detected end unit defect, automatically places an order with a repair center (7).

5. A system for processing complaints about mobile telephones, characterized by a service center (5) connected to the Internet (3) that accesses a problem/malfunction solution database (4), with the aid of which a problem/malfunction analysis is performed automatically in the dialog with the complainant (1) and corresponding solutions for solving the problem/malfunction are offered.

6. A system according to claim 5, characterized in that the service center (5) incorporates an IP tool in the form of a CBR program.
